(19) United States
(12) Patent Application Publication
(10) Pub. No.: US 2016/0208738 A1
(43) Pub. Date: Jul. 21, 2016

(54) TURBOJET ENGINE NACELLE COMPRISING A UNIT ASSEMBLY CAPABLE OF MOVING ALONG A GUIDE ASSEMBLY

(71) Applicant: AIRCELLE, Gonfreville L'orcher (FR)

(72) Inventors: Vincent PEYRON, Le Havre (FR); Laurent Georges VALLEROY, Le Havre (FR); Bouziane BEHRAOUI, Octeville s/mer (FR)

(21) Appl. No.: 14/703,144

(22) Filed: May 4, 2015

Related U.S. Application Data
(63) Continuation of application No. PCT/FR2013/052685, filed on Nov. 8, 2013.

(30) Foreign Application Priority Data
Nov. 9, 2012 (FR) 12/60623

(51) Int. Cl. F02K 1/54; F01D 25/24

(52) U.S. Cl. CPC F02K 1/54; F01D 25/24; F05D 2220/323; F05D 2260/50

(57) ABSTRACT

The present disclosure concerns an assembly including at least one unit assembly of a nacelle for a turbojet engine, and the assembly is movable relative to a fixed structure along at least one associated guide assembly. The guide assembly includes: at least one guiding element secured to the fixed structure; at least one guided element secured to the unit assembly, shaped so as to move along the guiding element; at least one contact surface common to said guiding and guided elements. In particular, the guided element and the guiding element present each at least one profile, and the profiles is non-complementary to each other at least at the contact surface, the profiles being shaped so as to achieve at least one plane abutment connection at least during circumferential forces of the unit assembly.

### CROSS-REFERENCE TO RELATED APPLICATIONS

This application is a continuation of International Application No. PCT/FR2013/052685, filed on Nov. 8, 2013, which claims the benefit of FR 12/60623, filed on Nov. 9, 2012. The disclosures of the above applications are incorporated herein by reference.

### FIELD

The present disclosure relates to a guide assembly for a movable unit assembly of a nacelle for a turbojet engine, and also concerns a thrust reverser equipped with such a guide assembly.

### BACKGROUND

The statements in this section merely provide background information related to the present disclosure and may not constitute prior art.

An aircraft is moved by several turbojet engines each housed in a nacelle also accommodating a set of auxiliary actuating devices related to its operation and providing various functions when the turbojet engine is in operation or stopped. These auxiliary actuating devices comprise in particular a mechanical system for actuating thrust reversers.

A nacelle generally presents a tubular structure comprising an air inlet upstream of the turbojet engine, a mid-section intended to surround a fan of the turbojet engine, a downstream section integrating thrust reversal means and intended to surround the combustion chamber of the turbojet engine, and is generally terminated by an ejection nozzle the outlet of which is located downstream of the turbojet engine.

Modern nacelles are intended to accommodate a bypass turbojet engine capable of generating, via blades of the rotating fan, a hot air flow (primary flow) and a cold air flow (secondary flow) which circulates outside the turbojet engine through an annular passageway, also called flow path, formed between a fairing of the turbojet engine and an inner wall of the nacelle. The two air flows are ejected from the turbojet engine from the rear of the nacelle.

The role of a thrust reverser during landing of an aircraft is to improve its braking ability by redirecting forward at least a part of the thrust generated by the turbojet engine. In this phase, the thrust reverser obstructs at least a part of the cold flow path and directs this flow to the front of the nacelle, thereby generating a counter-thrust which adds to the braking of the wheels of the aircraft.

The means implemented to achieve this cold flow redirection vary depending on the thrust reverser type.

A common structure of a thrust reverser comprises a cowling in which there is arranged an opening intended for the diverted flow which, in a direct thrust situation of the gases, is closed by a sliding cowl and which, in a thrust reversal situation, is freed by a downstream translation displacement (with reference to the flowing direction of gases) of the sliding cowl, by means of displacement cylinders of the sliding cowl, said actuating cylinders being mounted on a frame of the cowling upstream of the opening.

Most often, the sliding cowl is formed by two half-cowls, having a substantially semi-cylindrical shape, which are articulated, at the upper portion (at 12 o'clock) on hinges parallel to the translation direction of the sliding cowl, and which are closed by locks at the lower portion (at 6 o'clock).

This arrangement allows, for maintenance operations, accessing to the inside of the nacelle, and in particular the turbojet engine or an inner structure of the thrust reverser by opening these half-cowls.

Another possible thrust reversal structure comprises an outer single-piece assembly without breaking at the lower portion. Such a structure is called O-structure.

Such a structure is described, for example, in document FR 2 911 372.

In an O-structure, the outer structure is dissociated from the inner structure surrounding the engine and translated downstream, beyond a thrust reversal retracted position wherein it simply frees the thrust reverser cascades, so as to allow access to the engine body.

Whatever the retained mode of maintenance access, a C-structure or an O-structure, the cascade vanes always limit accessibility to the inside of the nacelle.

To do so, there are known some technological achievements based on the dismounting of the cascades in order to access to the cowl surrounding the engine body. Afterwards, some portions of the cowl are dismounted in order to finally be able to access to the engine body.

Such manipulations are time-consuming, difficult, and include risks of improper reassembling of elements subjected to forces in use such as, for example, the cascades or the inspection panels of the engine body.

In particular, we may refer to document US 2004/0159091 describing a set of cascades mounted so as to form an arc of circle terminated by slide rails. Such a solution allows facilitating the initial set-up of the cascades before fastening to the front frame. Nonetheless, during a maintenance operation, the access to the means for fastening to the front frame remains difficult and the removal of the cascades remains delicate and the risk of an improper reassembling of the cascades cannot be totally excluded.

There is also known a solution consisting in making the cascade vanes and the front frame supporting the cascade vanes, slide downstream of the nacelle, in order to access to the engine area for carrying out maintenance operations of the nacelle and the turbojet engine.

This solution, described in the patent application FR 2 952 681 belonging to the applicant, consists of a unit assembly, constituted by the front frame and the cascade vanes, which can be detached from the fan casing to which it is fastened, and can be translated downstream of the nacelle via a slider adapted to move along a runner secured to the pylon supporting the nacelle.

According to the prior art, the section of the runners is in general substantially semi-cylindrical so as to be able to allow for a slight angular displacement of the runner in case of a distortion between the fixed structure to which the movable assembly is connected.

In the active position, that is to say when the front frame is connected to the fan casing, the front frame is subjected to aerodynamic forces which tend to open the unit assembly constituted by the front frame and the cascade vanes downstream of the nacelle.

Typically, the experienced forces are typically circumferential compression forces, resulting in a rotation of the slider secured to the unit assembly about the longitudinal axis of the runner, as illustrated in FIG. 1 schematically representing the slider 19 which pivoted by some degrees relative to its standby position, in the runner 17 under the aerodynamic forces experienced by the unit assembly.

This rotation has the effect of resulting in an almost punctual contact between the slider and the runner at the area A, resulting in a bad transmission of the circumferential forces to the mast supporting the nacelle of the turbojet engine.

This bad take-up of the forces results in fatigue at the slider secured to the unit assembly, which may lead eventually to pull-out of the cascade vanes and the front frame supporting the cascade vanes.

### SUMMARY

The present disclosure provides an assembly comprising at least one unit assembly of a nacelle for a turbojet engine, movable relative to a fixed structure along at least one associated guide assembly, said guide assembly comprising:
at least one guiding element secured to the fixed structure;
at least one guided element secured to the unit assembly, shaped so as to move along the guiding element;
at least one contact surface common to said guiding and guided elements;
said assembly being remarkable in that the guided element and the guiding element present each at least one profile, the profiles being non-complementary to each other at least at said contact surface, said profiles being shaped so as to achieve at least one plane abutment connection at least during circumferential forces of said unit assembly.

According to the present disclosure, the guided element and the guiding element present each at least one profile, the profiles being non-complementary to each other at least at said contact surface, which means that the section of the guiding element at the surface of contact with the guided element is substantially geometrically distinct from the section of the guiding element.

Thus, by providing non-complementary profiles at the contact surface of the guiding and guided elements shaped so as to achieve at least one plane abutment connection at least during circumferential forces of said unit assembly, said contact surface is substantially increased at least during circumferential displacements of the unit assembly, which allows transmitting said forces to the fixed structure.

According to other features of the present disclosure:
the guiding element presents at least one contact surface having a substantially circular section;
the guided element presents at least two contact surfaces having a substantially elliptical section;
the contact surface of the guiding element comprises at least one substantially concave-shaped wall, and the contact surface of the guided element comprises at least one substantially convex-shaped wall;
the unit assembly of the nacelle comprises at least one front frame adapted to be mounted downstream of a fan casing of the turbojet engine and directly or indirectly supporting at least one flow deflection means;
the guiding element comprises at least one runner and the guided element comprises at least one slider.

The present disclosure also relates to a thrust reverser for a nacelle of a turbojet engine comprising at least one unit assembly, characterized in that said front frame is mounted movable in translation along at least one guide assembly according to the present disclosure.

Finally, the present disclosure concerns a nacelle for a turbojet engine comprising at least one thrust reverser according to the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a cross-sectional view of a guide assembly according to the prior art;

FIG. 2 is a general schematic representation of a nacelle of a turbojet engine comprising a cascade-type thrust reversal downstream structure, the thrust reverser device being in the closed position;

FIG. 3 illustrates the nacelle of FIG. 2, the thrust reverser device being in the deployed position;

FIG. 4 is a schematic sectional view of the thrust reverser device equipping the nacelle of FIG. 1;

FIG. 5 is a schematic representation of a cascades and front frame structure according to the present disclosure, equipping the thrust reverser device of FIG. 4;

FIG. 6 illustrates the nacelle of FIG. 2 in the maintenance position;

FIG. 7 is a cross-sectional view of a guide assembly according to the present disclosure, when the nacelle is in the standby situation;

FIG. 8 is a detailed profile view of the guiding element of the guide assembly;

FIG. 9 is a detailed profile view of the guided element of the guide assembly; and

FIG. 10 illustrates the guide assembly according to the present disclosure, when the nacelle is in the operation situation.

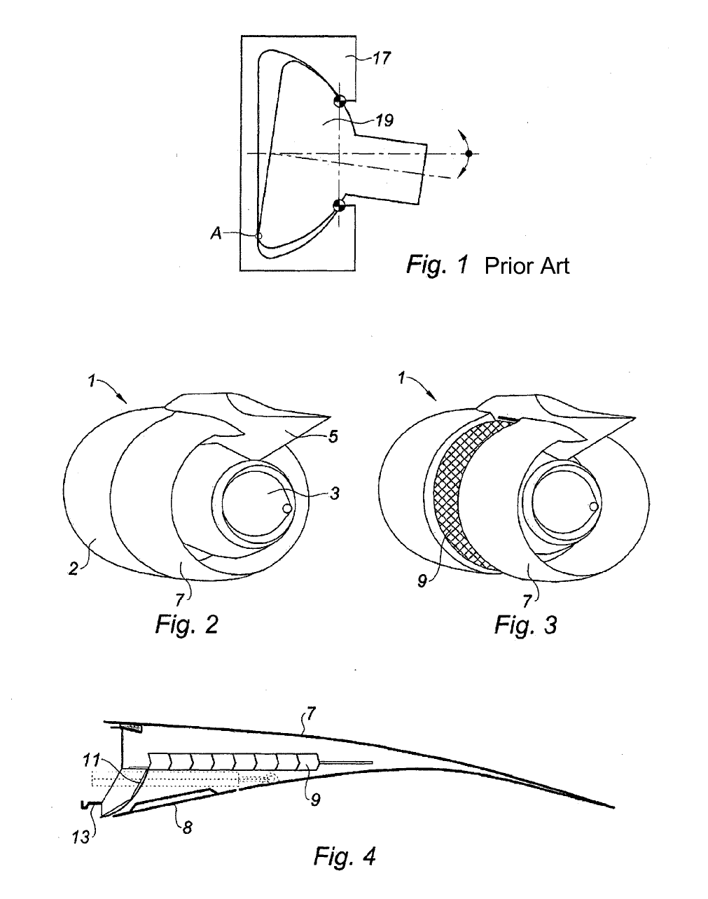

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Moreover, the terms <<upstream>> and <<downstream>> are defined with reference to the flowing direction of the air flow in the nacelle in direct jet operation, the upstream of the nacelle corresponding to a portion of the nacelle through which the flow penetrates, and the downstream corresponding to an area for ejecting said air flow.

Referring to FIG. 2, schematically illustrating a nacelle 1 of a turbojet engine 3 hanging under a wing (not represented) via an island 5 intended to serve as an interface with a mast or pylon (not represented).

This nacelle 1 is conventionally subdivided into an upstream air inlet section 2, a mid-section surrounding a fan (not represented) of the turbojet engine 3 and its casing, and a downstream section accommodating a thrust reverser device and optionally a terminal nozzle section.

The represented nacelle has a downstream section called <<O>> downstream section.

In FIG. 2, the thrust reverser device is represented in the closed position, according to which an outer cowl 7 provides the outer aerodynamic continuity of the nacelle with the upstream section and the mid-section and covers cascade vanes. Blocking flaps 8 (visible in FIG. 4) provide the inner aerodynamic continuity of the downstream section.

In the deployed position, which is represented in FIG. 3, the outer cowl 7 of the downstream section is moved backward downstream of the nacelle 1 so as to free an opening in the outer structure of the nacelle 1 and uncover the cascade vanes 9 capable of redirecting a portion of the air flow generated by the turbojet engine upstream of the nacelle 1 through the thus freed opening.

FIG. 4 shows a sectional view of the downstream section wherein the thrust reverser device is in the closed position.

The cascade vanes 9 are supported by a front frame 11 closing the thickness of the nacelle upstream of the outer cowl 7 and intended to be mechanically connected to the fan casing by connecting means 13.

The connecting means 13 can be detached from the fan casing, which allows freeing the front frame 11 from the fan casing and translating it downstream in order to make the inside of the nacelle 1 accessible. The detachable connecting means may consist of any known means, such as bolts, lock systems, etc.

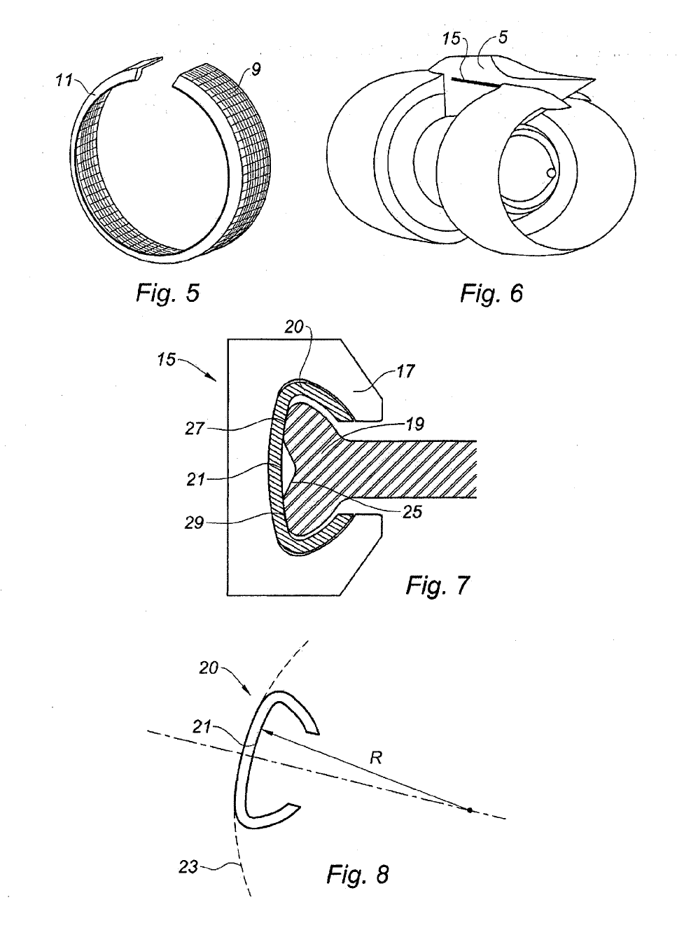

The assembly comprising the front frame 11 and the cascade vanes 9 then forms a unit assembly, as represented for example in FIG. 5.

The displaceable assembly may be monobloc or realized from a plurality of structures connected together in a rigid manner, in particular by bolting.

The displaceable assembly may also be subdivided into a plurality of sections that may be translated independently, or still into one or several fixed section(s) in locations that do not require specific accessibility.

It will be also noted that the cascade vanes 9 may be secured to the front frame or mounted in a detachable and displaceable manner independently.

The unit assembly may be displaced in a downstream position of the nacelle 1 in order to make the inside of said nacelle accessible for carrying out maintenance operations.

This maintenance position, illustrated in FIG. 6, is obtained by sliding the unit assembly, comprising at least the cascade front frame and the cascade vanes, relative to a fixed structure, comprising herein the upstream section of the nacelle and the island 5.

The displacement of the unit assembly relative to the fixed structure is performed along a guide assembly 15, advantageously located proximate to the island 5, or to the area intended to receive the pylon in the case where the nacelle were directly connected to the pylon, with no island.

FIG. 7 schematically represents a cross-sectional view of a form of the guide assembly 15 according to the present disclosure, illustrated in the standby position.

By standby position is meant a position according to which the unit assembly experiences no force that tends to move it downstream of the nacelle, unlike an operation situation, for which the unit assembly experiences forces that tend to make it slide downstream of the nacelle.

The guide assembly 15 comprises a guided element secured to the movable unit assembly of the nacelle, constituted, for example, by the front frame/cascade vane assembly, and a guiding element secured to the island or to the mast or pylon if there is no island.

In fact, the assembly according to the present disclosure comprises two guide assemblies located on either side of the island or of the mast or pylon if there is no island, each comprising a guided element and a guiding element.

More precisely, the guide assembly comprises, on the one hand, a guiding element comprising a runner 17 fixed on the island, or on the mast or pylon if there's no island and, on the other hand, a guided element comprising a slider 19 which may be integrated to the cascade vanes and/or to the front frame, or still affixed on said cascades or on said frame, and shaped so as to move along the runner when passing from an operation position to a maintenance position.

As illustrated, the runner 17 receives a sock 20 in contact with the slider 19. Nonetheless, it should be understood that although the presence of the sock 20 facilitates the displacement of slider in the runner, it is only optional, and it may be considered to provide a guide assembly comprising a slider 19 directly mounted in the runner 17, with no sock.

Furthermore, the arrangement may be reversed, namely the runner may be integrated to the cascade vanes and/or to the front frame, or affixed on said cascades or on said frame, and the slider may be fixed on the island, or on the mast or pylon if there is no island.

In addition, the runner 17 may have various lengths. In particular, it may extend along the entire unit assembly, or only a portion thereof.

In such a standby situation, the contact surface between the sock 20 (or the runner 17) and the slider 19 presents two contact areas B and C distinct from each other.

The contact surface of the sock 20 (or of the runner 17) presents a substantially concave-shaped wall 21. The cross-section of said contact surface of the sock is substantially circular, as represented in FIG. 8 illustrating the sock 20.

As illustrated in this Figure, representing the sock 20, the radius R of the circle 23 is about 30 millimeters, which, of course, constitutes only but an example of one form which should be adapted depending on the unit assembly to be displaced.

Referring again to FIG. 7, the contact surface of the slider 19 presents a substantially convex-shaped wall 25.

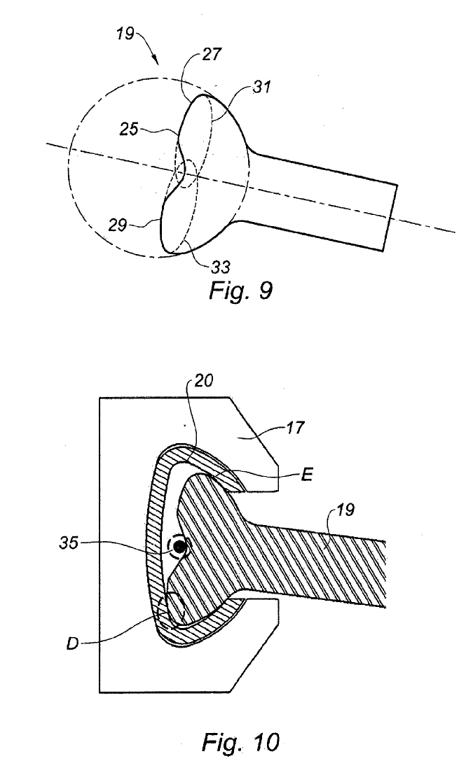

Referring to FIG. 9 illustrating the slider 19, the cross-section of the contact surface of the slider presents two contact surfaces 27, 29 distinct from each other, each having at least partially a substantially elliptical section respectively along a first ellipse 31 and along a second ellipse 33.

As previously, the dimensions of the ellipses represented in FIG. 9 constitute only but a non-limiting example, and may need to be modified depending on the assembly of the nacelle to be displaced.

In the operation situation of the nacelle, which position is represented in FIG. 10, the cascade vanes 10 (not represented in this figure) tend to move downstream of the nacelle and rotate by some degrees, for example between about 3° and 9°.

In such a situation, the slider 19 rotated about an axis 35 substantially longitudinal relative to the runner 17. The contact surface between the sock 20 (or the runner 17) and the slider 19 presents substantially two areas D and E distinct from one another.

As illustrated, the contact between the slider 19 and the runner 17 at the area D can be modeled as a plane abutment connection. By providing such non-complementary profiles, when the nacelle is in the operation situation, the contact surface between the runner and the slider is hence substantially increased compared to the contact surface obtained in the prior art, which allows for a better transmission of the forces, in particular the circumferential forces, from the unit assembly to the mast supporting the nacelle.

Although the present disclosure has been described with a particular example of form, it is obvious that it is in no way limited thereto and that it comprises all technical equivalents of the described means as well as their combinations if they are within the scope of the present disclosure.

For example, such a guide assembly may absolutely be used to translate the thrust reverser cowl between a direct jet position and a reverse jet position, or between an operation position and a maintenance position if those skilled in the art find a particular interest by doing so.

What is claimed is:

1. A nacelle for a turbojet engine comprising:
a fixed structure; and
at least one unit assembly movable relative to the fixed structure along at least one associated guide assembly;
said at least one guide assembly comprising:
at least one guiding element secured to the fixed structure;
at least one guided element secured to said at least one unit assembly, shaped so as to move along said at least one guiding element; and
at least one contact surface common to said at least one guiding and guided elements,
wherein said at least one guided element and the guiding element of said guide assembly present each at least one profile, said at least one profile being non-complementary to each other at least at said contact surface, the guiding element presenting at least one contact surface having a substantially circular section and the guided element presenting at least two contact surfaces having a substantially elliptical section.

2. The nacelle according to claim 1, wherein the contact surface of said at least one guiding element comprises at least one substantially concave-shaped wall, and the contact surface of said at least one guided element comprises at least one substantially convex-shaped wall.

3. The nacelle according to claim 1, wherein said at least one unit assembly comprises at least one front frame adapted to be mounted downstream of a fan casing of the turbojet engine and directly or indirectly supporting at least one flow deflection means.

4. The nacelle according to claim 1, wherein said at least one guiding element comprises at least one runner and said at least one guided element comprises at least one slider.
